(19) United States
(12) Patent Application Publication
(10) Pub. No.: US 2009/0135006 A1
(43) Pub. Date: May 28, 2009

(54) INFRASTRUCTURE DEVICE WITH MODULAR REMOTE SENSORS

(75) Inventor: Roland Schoettle, American Canyon, CA (US)

Correspondence Address: OPTIMAL TECHNOLOGIES, INC., 1001 West 4th St., Winston-Salem, NC, 27101, US

(73) Assignee: Optimal Innovations Inc., Bridgetown (BB)

(21) Appl. No.: 11/944,936

(22) Filed: Nov. 26, 2007

(51) Int. Cl. G05B 23/02; G08B 21/00

(52) U.S. Cl. 340/540; 340/500; 340/3.1

(57) ABSTRACT

The present invention is directed to a system and method which allows a user to mount a utility function monitoring element in a location where the monitoring element can detect a desired stimulus, even when the mounting location is remote from an access point to the premises infrastructure wiring. In one embodiment, the monitoring element is registered with a control device mounted within a particular utility box. In such a situation, the monitoring element communicates with the utility box control device either wirelessly or via the premises electrical wiring.

### CROSS-REFERENCE TO RELATED APPLICATIONS

This application is related to U.S. patent application Ser. No. 11/683,298 filed Mar. 7, 2007 entitled “LIGHT SWITCH USED AS A COMMUNICATION DEVICE”; U.S. patent application Ser. No. 11/683,326 filed Mar. 7, 2007 entitled “ANTICIPATORY UTILITY CONTROL DEVICE”; U.S. patent application Ser. No. 11/683,335 filed Mar. 7, 2007 entitled “PLUG AND PLAY UTILITY CONTROL MODULES”; U.S. Provisional Patent Application No. 60/956,314 filed Aug. 16, 2007 entitled “UTILITY OUTLETS AS A SECURITY SYSTEM”; U.S. Provisional Patent Application No. 60/940,010 filed May 24, 2007 entitled “LIGHT SWITCH AS A WIRELESS HUB”; U.S. Provisional Patent Application No. 60/940,010 filed May 24, 2007 entitled “UTILITY OUTLETS AS REMOTE CONTROL REPEATERS”; U.S. Provisional Patent Application No. 60/956,306 filed Aug. 16, 2007 entitled “USING UTILITY OUTLETS TO DETERMINE AND REPORT MEDIA-BASED ACTIVITY”, U.S. patent application Ser. No. 11/875,712 filed Oct. 19, 2007 entitled “SIZE UNCONSTRAINED FACEPLATE DISPLAY FOR USE WITH INFRASTRUCTURE DEVICE,” U.S. patent application Ser. No. 11/875,726 filed Oct. 19, 2007 entitled “INFRASTRUCTURE DEVICE WITH REMOVABLE FACE PLATE FOR REMOTE OPERATION,” and U.S. patent application Ser. No. (not yet issued) filed concurrently herewith, Attorney Docket No. 66816-P037US-10715042 entitled “INFRASTRUCTURE DEVICE WITH MODULAR REPLACEABLE SENSORS,” the disclosures of which are incorporated herein by reference.

### TECHNICAL FIELD

This disclosure relates to infrastructure utility devices and more particularly to such devices having modular sensors.

### BACKGROUND OF THE INVENTION

Utility devices are devices that are mounted to a premises infrastructure. Lights, light switches, electrical power sockets are typical examples of utility devices. One aspect of an infrastructure device is that it is connected, at least electrically, to wiring affixed to the premises structure. Another aspect of an infrastructure device is that it is connected via wired or wireless communications to devices that are themselves connected electrically to the premises electricity delivery infrastructure. In some situations, a standalone light switch that has a sensor can act to alarm locally (without being part of a bigger grouping) for fire and other environmental parameters. For the purposes of having sensors remote from the device, that act as part of it, there must be a method of communicating with the device.

A light switch is one form of an infrastructure device. An electrical outlet is another form of such a device. A TV, radio, security system, surveillance system, premise-based communication system, or game box is yet another form of such device. Other infrastructure devices can be, for example, a wide variety of sensors/systems such as are obvious (e.g., light switches, plugs, thermostats, inline power boxes, etc) but also non-obvious sensors/systems such as light sensors, temperature sensors, internet access systems, WAN system, LAN systems, RF systems, display systems, power sensors, power supply systems, schedulers, clocks, audio/video systems, intercom systems, telephone systems, HVAC systems, television, radio, cameras, proximity sensors, occupancy sensors, motion sensors, GPS, entertainment systems, safety monitoring systems, security systems, fire monitoring systems, surveillance systems, messaging systems, alert and alarm systems, medical monitoring systems, data monitoring systems, data control systems, access monitoring systems, access control systems, legacy remote control systems (e.g., TVs, radios, lighting), media reader systems, identification systems, humidity sensors, barometric pressure sensors, weight sensors, traffic pattern sensors, power quality sensors, operating costs, power factor sensors, meters, storage systems, distributed generation systems, UPS systems, battery monitoring systems, priority systems, inertia sensors, glass break sensors, fire sensors, flood sensors, vibration sensors, smoke sensors, carbon dioxide sensors, carbon monoxide sensors, ultrasound sensors, infra-red sensors, microwave sensors, radiation sensors, bacteria sensors, bio-hazard sensors, disease sensors, poison sensors, germ sensors, toxic material sensors, air quality sensors, laser sensors, load sensors, stress sensors, cantilever sensors, material sensors, load control systems, etc.

Utility devices are positioned within utility boxes fastened to the infrastructure. In the context of this discussion, utility box includes the typical box mounted to the premises structure into which a device, such as a switch, is mounted. Utility box, however, also includes devices that mount to (“tacked” onto) the surface of the structure, such as, for example, a thermostat. In a typical environment, the utility device is connected to infrastructure wiring. However, many other types of devices can also be mounted in a utility box framework.

Many premises functions are controllable from a utility control device. For example, in the most simple of operations, the operation of a switch by a user causes a light to go on or off. This presumes the switch is positioned in a location convenient for the user. However, since these switches are mounted in utility boxes that are permanently fastened to the premises infrastructure, it is not easy to rearrange the physical location of the switch. Thus, when a switch is located in a utility box that is in an inconvenient location, changing the location is difficult and sometimes not even possible.

One example of an inconvenient situation is when it is desired to use motion or light sensors for control of a premises function. The motion sensor (or light sensor) must be mounted where it will detect the desired motion (or the triggering light level). Such devices are designed to be mounted in utility boxes and act as a user activated switch would if the switch were to be mounted in such a utility box. Often however, the utility box is positioned in anticipation of a user activating the switch which may not be the best location for a motion activated sensor to be located. In some situations, such automated switches can not be used due to a lack of access to premises wiring at a location where the sensor should be located in order to allow it to properly detect the desired stimulus. This is also true of many other sensor and interface types (e.g., temperature, display panels, security panels, security sensors, biohazard sensors, and many more).

### BRIEF SUMMARY OF THE INVENTION

The present invention is directed to a system and method which allows a user to mount a utility function control element in a location where the control element can detect a desired stimulus, even when the mounting location is remote from an access point to the premises infrastructure wiring. In one embodiment, the control element is registered with a control device mounted within a particular utility box. In such a situation, the control element communicates with the utility box control device either wirelessly, via dedicated wires, or via the premises electrical wiring.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows an infrastructure utility device in accordance with one aspect of the invention;

FIG. 2 shows a portion of the utility device being mounted at a location remote from the utility wiring access point; and

FIG. 3 shows details of one embodiment of a removable portion of a utility device.

### DETAILED DESCRIPTION OF THE INVENTION

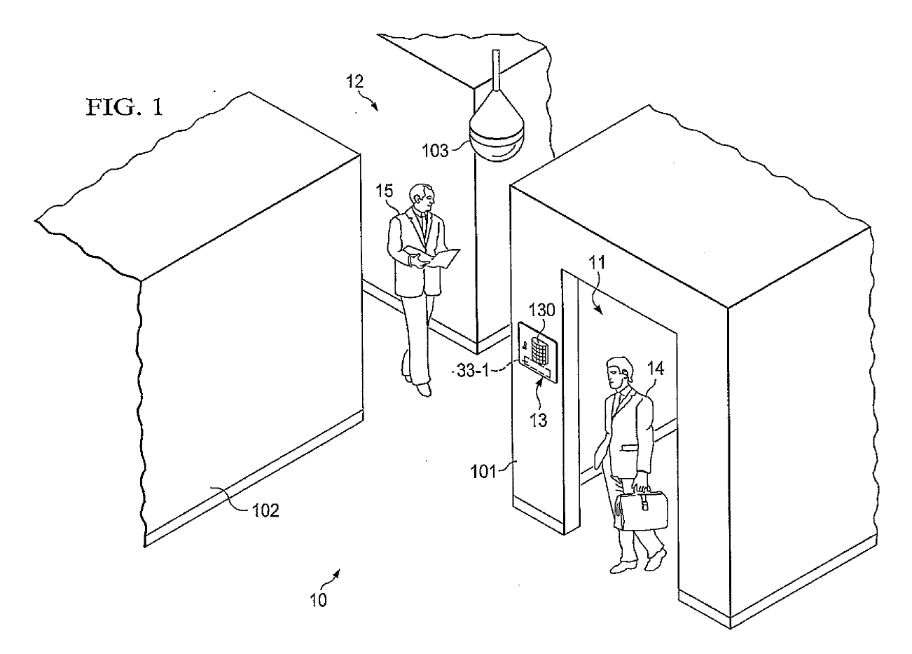

FIG. 1 shows one embodiment 10 of an infrastructure utility device, such as device 13, being used as an infrastructure device. In this embodiment, device 13 is mounted in a utility box (not shown) on wall surface 101. Device 13 is a motion sensor having element 130 which detects motion and controls via an electrical switch a utility device, such as light 103, in response to the detected motion. Thus, when user 14 walks through door 11 light 103 will activate based upon the motion of user 14 in the “view” of sensor element 130. In the preferred embodiment, the connection to the infrastructure is within a utility device, but other devices, such as thermostats, intercoms, door bells, smoke alarms, audio and video panels, some cable outlets, phone jacks, etc., can be “tacked” into the premises wiring, and, as discussed above, are considered to be within utility boxes.

However, it is also desired that light 103 come on when user 15 walks through door 12. One way to accomplish this would be to have a three-way motion sensor switch located on wall 102 working in cooperation with switch 130. However, to do so would require a modification to the premises wiring which is not always an easy task to accomplish. Another method would be to allow user 15 to walk down a dark hall until he/she comes into the “view” of sensor (monitor) 130. This procedure has obvious drawbacks.

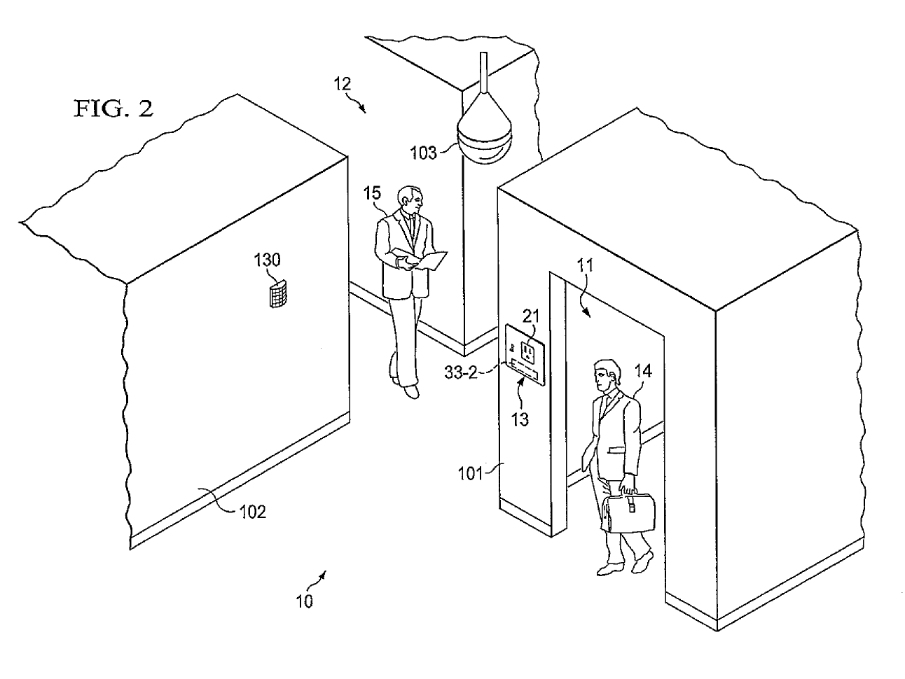

FIG. 2 shows sensor portion 130 of utility device 13 mounted (“tacked”) on wall 102 at a location remote from a utility wiring access point. Sensor 130 is mounted in a position so that it has a “view” of user 14 as well as user 15 when either enters the protected space. Thus, a single utility box location, in this case location 13, can serve multi-points.

In another embodiment any one wall switch or other utility devices can be “tagged” to numerous remote and/local sensors. In yet another embodiment, any one sensor can be “tagged” to numerous wall switches or other utility devices.

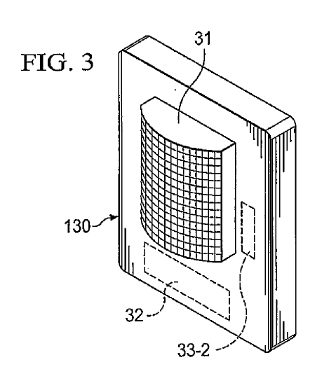

As shown in FIG. 3, monitor 130 has a monitoring portion 31 and can contain a communication element, such as transmit/receive device 32, which communicates with transmit/receive device 31 contained in host device 130 or can be hard wired if desired. This element then works in conjunction with element 16 of host device 13 so as to send operational signals wirelessly (or by wireline if desired) to the host so that the host, in turn, can control another utility device, such as light 103. Thus, while the location of the utility access point is fixed, the device or devices hosted by the access point can be located remote therefrom. Sensor 130 can be any type of monitoring device, such as is used for control, sensing, measuring, verification, etc.

Note that while device 13 is shown as a single function device, it can have multiple functions and, if desired, can be removable as well. Thus, in one embodiment, the faceplate of a utility device can be moved to one location (as discussed in the above-identified patent application “INFRASTRUCTURE DEVICE WITH REMOVABLE FACE PLATE FOR REMOTE OPERATION” operational elements of the faceplate can be located remote from the faceplate and/or remote from the utility box.

Also note that while the embodiment being discussed implies that a portion of the sensor device remains with the utility box while the sense element is remote other embodiments can be used where the sensor communicates with a receiver positioned in the utility device portion 130 can be positioned for periods of time in device 13, via, for example, electrical connector 21 (for charging or other purposes). In some embodiments the monitor portion is always remote from the base or host and can be “tagged” to one or more hosts in any well-known manner, for example, using tag control 33-1, 33-2 so that monitors and hosts can be obtained independent from each other.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A utility device comprising:
a first portion for electrically connecting to premises infrastructure wiring;
a second portion for electrically mating with said first portion, said second portion operable for monitoring at least one premises function via said mated relationship with said first portion; and wherein said monitoring can be from a location physically remote from said first portion.

2. The utility device of claim 1 wherein said mated relationship is a wireless connection.

3. The utility device of claim 2 wherein said mated relationship is a direct wired relationship.

4. The utility device of claim 1 wherein said second portion is selected from the list of detectors, monitors, and sensors: CO; CO₂; biohazard; fire; video; audio; messages; alerts; alarms; medical condition; data type; access; remote control (e.g., for TVs, radios, lighting); media; identification; humidity; barometric pressure; weight (mass); traffic patterns; occupancy; motion; power quality; operating cost; power factor; voltage; frequency; current; phasor; phase angle; impedance; active power; reactive power; energy storage; battery condition; priority; proximity; inertia; selective audio frequency (audio recognition, e.g., voice, glass break); selective video (visual recognition, e.g., terrorist); flooding; vibration; smoke; radiation; ultrasound; acoustic sound; infrasound; infrared; light; microwave; radio frequency; electromagnetic radiation; nuclear radiation; coherent radiation; bacteria; bio-hazards; diseases; poisons; germs; toxic materials; air quality; load; stress; material type.

5. The utility device of claim 1 wherein said at least one premises function is selected from first portion comprising:
electric light; motion sensor, clock, temperature sensor, monitor, intercom, speaker, temperature control, humidistat, CO detector; CO₂ detector; biohazard detector; fire detector; video display; message panel; alert panel; alarm panel; medical monitor; data access panel; data access interface; physical access panel; physical access interface; multimedia interface; identification interface; barometric pressure monitor; weight (mass) monitor; traffic pattern monitor; occupancy monitor; motion monitor; power quality monitor; operating cost monitor; power factor monitor; voltage monitor; frequency monitor; current monitor; phasor monitor; phase angle monitor; impedance monitor; active power monitor; reactive power monitor; energy storage monitor; battery condition monitor; priority monitor; proximity monitor; inertia monitor; selective audio frequency monitor (audio recognition, e.g., voice, glass break); selective video monitor (visual recognition, e.g., terrorist); flooding monitor; vibration monitor; smoke monitor; radiation monitor; ultrasound monitor; acoustic sound monitor; infrasound monitor; infrared monitor; light monitor; microwave monitor; radio frequency monitor; electromagnetic radiation monitor; nuclear radiation monitor; coherent radiation monitor; bacteria monitor; bio-hazard monitor; disease monitor; poison monitor; germ monitor; toxic material monitor; air quality monitor; load monitor; stress monitor; material type monitor.

6. A device for use in a utility box, said device comprising:
means for electrically connecting a first portion of said device to premises wiring within said utility device, and
means for allowing a second portion of said device to monitor a premises function via said electrically connected first portion, while said second portion is located remote from said utility box.

7. The utility device of claim 6 wherein said second portion is selected from the list of detectors, monitors, and sensors: CO; CO₂; biohazard; fire; video; audio; messages; alerts; alarms; medical condition; data type; access; remote control (e.g., for TVs, radios, lighting); media; identification; humidity; barometric pressure; weight (mass); traffic patterns; occupancy; motion; power quality; operating cost; power factor; voltage; frequency; current; phasor; phase angle; impedance; active power; reactive power; energy storage; battery condition; priority; proximity; inertia; selective audio frequency (audio recognition, e.g., voice, glass break); selective video (visual recognition, e.g., terrorist); flooding; vibration; smoke; radiation; ultrasound; acoustic sound; infrasound; infrared; light; microwave; radio frequency; electromagnetic radiation; nuclear radiation; coherent radiation; bacteria; bio-hazards; diseases; poisons; germs; toxic materials; air quality; load; stress; material type.

8. The utility device of claim 6 further comprising:
means for allowing said function to be performed from said utility box while said second portion is remote there from.

9. A utility device comprising:
at least one removable control device adapted for mounting within a utility box, said mounting being concurrently with at least one electrical control/monitoring device selected from the list of: electrical switch, electrical outlet socket, electric light; motion sensor, clock, temperature sensor, monitor, intercom, speaker, temperature control, humidistat, CO detector; CO₂ detector; biohazard detector; fire detector; video display; message panel; alert panel; alarm panel; medical monitor; data access panel; data access interface; physical access panel; physical access interface; multimedia interface; identification interface; barometric pressure monitor; weight (mass) monitor; traffic pattern monitor; occupancy monitor; motion monitor; power quality monitor; operating cost monitor; power factor monitor; voltage monitor; frequency monitor; current monitor; phasor monitor; phase angle monitor; impedance monitor; active power monitor; reactive power monitor; energy storage monitor; battery condition monitor; priority monitor; proximity monitor; inertia monitor; selective audio frequency monitor (audio recognition, e.g., voice, glass break); selective video monitor (visual recognition, e.g., terrorist); flooding monitor; vibration monitor; smoke monitor; radiation monitor; ultrasound monitor; acoustic sound monitor; infrasound monitor; infrared monitor; light monitor; microwave monitor; radio frequency monitor; electromagnetic radiation monitor; nuclear radiation monitor; coherent radiation monitor; bacteria monitor; bio-hazard monitor; disease monitor; poison monitor; germ monitor; toxic material monitor; air quality monitor; load monitor; stress monitor; material type monitor, said electrical control device adapted for becoming electrically connected to premises electrical wiring within said premises utility box;
means for allowing said removable control device to be removed from said utility box separate from a removal of any device concurrently mounted in said utility box; and
means for enabling a removed device to control a specific utility device via wireless communication with said utility box.

10. The utility device of claim 9 further comprising:
means for allowing said removable control device to become electrically physically connected to said premises wiring while said removable control device is within said utility box.

11. The utility device of claim 9 further comprising:
means for allowing said removable control device to become electrically physically connected to at least one of said electrical control devices while said removable control device is within said utility box.

12. A utility device comprising:
an electrical monitoring device selected from the list of: electrical switch, electrical outlet socket, electric light; motion sensor, clock, temperature sensor, monitor, intercom, speaker, temperature control, humidistat, CO detector; CO₂ detector; biohazard detector; fire detector; video display; message panel; alert panel; alarm panel; medical monitor; data access panel; data access interface; physical access panel; physical access interface; multimedia interface; identification interface; barometric pressure monitor; weight (mass) monitor; traffic pattern monitor; occupancy monitor; motion monitor; power quality monitor; operating cost monitor; power factor monitor; voltage monitor; frequency monitor; current monitor; phasor monitor; phase angle monitor; impedance monitor; active power monitor; reactive power monitor; energy storage monitor; battery condition monitor; priority monitor; proximity monitor; inertia monitor; selective audio frequency monitor (audio recognition, e.g., voice, glass break); selective video monitor (visual recognition, e.g., terrorist); flooding monitor; vibration monitor; smoke monitor; radiation monitor; ultrasound monitor; acoustic sound monitor; infrasound monitor; infrared monitor; light monitor; microwave monitor; radio frequency monitor; electromagnetic radiation monitor; nuclear radiation monitor; coherent radiation monitor; bacteria monitor; bio-hazard monitor; disease monitor; poison monitor; germ monitor; toxic material monitor; air quality monitor; load monitor; stress monitor; material type monitor, said electrical control device(s) adapted for becoming electrically connected to premises electrical wiring within a premises utility box, said electrical connections operative to allow said control device to control utility functions; and
a renewable monitoring element mounted in conjunction with said control devices, said renewable monitoring element operative in conjunction with a monitoring device for controlling one of said utility functions.

13. The utility device of claim 12 further comprising:
means for allowing said renewable monitoring device to be removed from said utility box without separating said renewable monitoring device from said control of said utility function.

14. A method for operating a premises utility function, said method comprising:
removing at least a portion of a monitoring device from a premises utility box;
allowing a removed monitoring module to continue to monitor a premises utility function from a location remote from said utility box; and
receiving at said utility box control information from said removed monitoring portion.

15. The method of claim 14 further comprising:
positioning said monitoring module in a fixed location remote from said utility box for a period of time, said position being selected to allow said monitoring module to be in a better location to sense a stimulus than it would be in if said monitoring module were to be located at said utility box.

16. The method of claim 15 further comprising:
returning said monitoring module to said utility box for a period of time.

17. The method of claim 15 wherein said monitoring module communicates with said utility box via at least one of the following: wirelessly, via communications over premises wiring.

18. A method for operating a premises utility function, said method comprising:
registering a monitoring module with a particular premises function monitoring device mounted within a utility box; and
allowing said registered monitoring module to control said particular premises utility function from a location remote from said utility box.

19. The method of claim 18 further comprising:
positioning said monitoring module in a fixed location remote from said utility box for a period of time, said position being selected to allow said monitoring module to be in a better location to sense a stimulus than it would be in if said monitoring module were to be located at said utility box.

20. The method of claim 18 wherein said monitoring module communicates with said utility box via at least one of the following: wirelessly, via communications over premises wiring.

21. The method of claim 18 further comprising:
allowing said registered monitoring module to be “tagged” to any number of control modules.

22. The method of claim 18 further comprising:
allowing said registered control module to be “tagged” to any number of monitoring modules.

23. A monitoring module for use with at least one premises connected control devices, said module comprises:
an element for sensing at least one particular condition at a location remote from at least one premises mounted control device; and
means for communicating sensed conditions to said at least one said control device such that said control device can perform an electrical action with respect to a device connected to said control device.

24. The monitoring module of claim 23 further comprising:
means for tagging said module for association with at least one particular control device.
